(19) United States
(12) Patent Application Publication
(10) Pub. No.: US 2007/0280174 A1
(43) Pub. Date: Dec. 6, 2007

(54) Small Geographical Area Cell-based Dynamic Source Routing for Mobil Ad-hoc Networks

(75) Inventor: NGAN-CHEUNG PUN, Fairport, NY (US)

Correspondence Address: NGAN-CHEUNG PUN, 98 HAMMOCKS DRIVE, FAIRPORT, NY, 14450, US

(73) Assignee: NGAN-CHEUNG PUN, FAIRPORT, NY (US)

(21) Appl. No.: 11/308,987

(22) Filed: Jun. 3, 2006

(51) Int. Cl. H04Q 7/24

(52) U.S. Cl. 370/338; 370/401

(57) ABSTRACT

This invention is about creating a new routing protocol, called Small Geographical Area Cell-based Dynamic Source Routing (SGA-DSR), for the mobile ad-hoc network systems (MANET). The design of this SGA-DSR protocol has greatly reduced the routing overheads over the many other MANET protocols. Because of the routing overhead reduction and its insensitive to the network density, SGA-DSR scales very well to fairly large networks such as covering the whole area, having over thousands of nodes. In all geographical based protocols, the positions and the geographical area boundaries are used in their special ways. Here, in SGA-DSR, the SGA based cells are constructed in a special way. The routing routes are much less affected by the dynamics of the topology changes.

### CROSS-REFERENCE TO RELATED APPLICATIONS

The present Application for Patent claims priority to Provisional Application Ser. No. 60/671,265, entitled “Small Geographical Area Cell-base Dynamic Source Routing (SGA-DSR) for Mobile Ad-hoc Networks (MANET)”, filed Apr. 14, 2005.

### FEDERALLY SPONSORED RESEARCH

Not Applicable

### SEQUENCE LISTENING OR PROGRAM

Not Applicable

### FIELD OF THE INVENTION

The present invention relates generally to the systems and methods for solving routing problem in the Mobile Ad-hoc Networks (MANET). More specifically, it reduces the routing overhead in route searching and route tracking so that it can be used in large networks.

### BACKGROUND OF THE INVENTION

Overview of the Mobile Ad-hoc Network Systems (MANET): An ad hoc network is an autonomous system of mobile stations connected by wireless links. In such a network, each mobile station possesses some routing capabilities. The mobile station may move randomly relative to each other so that the topology may change rapidly and unpredictably. Mobile nodes communicate with each other in the absence of a fixed infrastructure. Due to propagation path loss, the transmission range is limited. Thus, the connected routes between two nodes in network may consist of hops through other intermediate nodes in the network. The task of finding and maintaining routes in the network is nontrivial since host mobility causes frequent unpredictable topological changes. Some mobile nodes may go into sleep mode, or some other mobile nodes may just come out of sleep mode.

Protocol Performance Measurement: The problem of routing in mobile wireless networks is far from being solved. There are over hundreds of MANET protocols proposing different ways to solving the dynamic routing problems. The performance of different protocols vitiates over different areas of measurement. In general, the ad-hoc protocol performance can be classified into the following items:
(1) Routing overhead. It can be defined as the average number of routing and control bits transmitted per data bits delivered. Control bits include the cost of destination route search, location updates, keep-alive updates, and retransmission during routing process.
(2) Delivery rate. Delivery rate is defined as the ratio of numbers of messages received by destination and sent by source node. Since, the mobiles move in the network, new connection links are formed and existing links become broken rapidly, some packets may be dropped due to out-dated routing information. The measurement is to gauge how well the routing protocol updates the change in the network topology.
(3) Scale To Large Network. It is a measurement of the scalability of the protocol in terms of the routing overhead; route maintenance, etc verses the network density and network size.
(1) Loop Free. The protocol design should consider the possibility of loop formation due to the mobility of the nodes and the rapid change of the network topology.
(2) Network Density, sparse and dense networks. The network density is defined by the average number of mobiles falls into the radius of the radio transmission. Transmission radius R of a node is limited. In a sparse network, there could be little or short connections between nodes and very often, there could be no connections at all. The network topology changes rapidly in terms of connectivity. In dense networks, there may be large number nodes in a defined area. The huge number of nodes and their relative connectivity changes may pose a huge routing overhead and route maintenance for the protocol. A protocol performs well in the sparse network may not indicate its same performance in the dense network.
(3) Node mobility. It is defined as the average speed of the nodes in the network. Random walks tend to keep all nodes close to their initial positions, and it is not regarded as a good model. The random waypoint model is often used. Each node generates a random next position and walks with a constant speed towards that position. The node then waits for a period of time, called pause time. It does not move before the pause period expired.
(4) Comparison with the shortest path algorithm. The route acquired by the protocol is compared to the ideal shortest path (SP) algorithm, which calculates the shortest path on full knowledge of the network topology. Most of the protocols have good performance in this aspect.
(5) Multi-path to Destination. It is defined as the capability of supporting the multiple routes to the destination. The multiple routes information may be distributed in separate nodes as hop-to-hop route entries or as completed route paths.
(6) Independent on Link layer and Physical Layer. The protocol design should be independent of the Link Layer and Physical Layer. Some protocol may use some specific part of the underlying layers as assumptions.
(7) Asymmetrical Links. It is defined as the capability to support unidirectional links. It is common in the wireless network that one node can transmit to another but the reverse direction is blocked or not reachable.
(8) Distributed Computation Power. The nodes in the network have limited computation power and battery power. If the route computation is focused on a small set of selected nodes, the network may be unstable due to the more prone failure at those nodes.
(9) Protocol Simplicity. It is a relative measure of how complex the routing protocol design is. On way to measure the complexity is the number of different control packet types. It is also about how easy it is to implement such a protocol.
(10)
(11)

Classification of routing algorithms and protocol examples:
(1) Table-Driven Routing
   Destination-Sequenced Distance-Vector Routing (DSDV)
   Wireless Routing Protocol (WRP)
   Global State Routing (GSR)
   Fisheye State Routing (FSR)
(2) Source-initiated On-Demand Routing
   Dynamic Source Routing (DSR)
   Ad-hoc On-Demand Distance Vector Routing (AODV)
   Associativity Based Routing protocol (ABR)
(3) Hierarchical-based Routing
   Cluster head Gateway Switch Routing (CGSR)
   Zone Routing Protocol (ZRP)
   Zone-based Hierarchical Link State Routing (ZHLS)
   Hierarchical State Routing (HSR)
(4) Geographical Based Routing
   Distance Routing Effect Algorithm for Mobility (DREAM)
   Geographic Location Service (GLS)
   Location-Aided Routing protocol (LAR)
   GPS Ant-Like Routing Algorithm (GPSAL)
   Zone-Based Hierarchical Link State Routing (ZHLS)
   Greedy Perimeter Stateless Routing (GPSR)

The Issues with algorithms in existing MANET protocols:
(1) Table Driven and Demand-based operation: Routing algorithms can be classified as proactive [Table-Driven Routing] or reactive [On-Demand Routing].
   Proactive protocols maintain routing tables when links changed are detected, due to node movement or radio path loss. It works independently of traffic demand, and thus may have unacceptable overhead. For instance, route updates are too sensitive to small topology changes. The communication overhead involved in maintaining global information about the networks is not acceptable for networks whose bandwidth are battery power are severely limited.
   Reactive algorithms acquire routes when they are needed. One of well-known reactive algorithms is the source-initiated on-demand routing strategy, such as DSR, ABR, AODV, etc. In this method, the source node S issues destination search request, also known as route request, if route to destination D is not available. The request message propagates to each node in the network. Flooding algorithms is expensive in routing overhead as it is proportional to the number of nodes in the network. The advantage is that it is simple, loop-free and does not require any priori knowledge of the network topology and it has little maintenance. The destination search can be reduced slightly if the intermediate nodes cache the routes it overheard. In a dynamic network, the nodes move and the topology change rapidly. The cached route may not be updated as time passes. Some algorithm combines the use of proactive and reactive approaches. The nodes have knowledge of the local neighbors but regular local neighbor update is required. However, flooding for destination search is still required, it the destination is not in the direct neighborhood.
(2) Hierarchical-based and Zone based approaches localize the small topology change to a zone. The zones are non-overlapping geographical areas. Within a zone, the nodes have full knowledge of each node connection in the zone. For destination outside the zone, inter-zonal destination searches are used. One issue with the zone-based is that the nodes move in and out of the zone cause intra-zone routing updates. And the location update is again broadcasted to other zones. Global inter-zone routing table is not needed if the linkage between two adjacent zones is not changed. Additional problem arises when the network is partitioned and separated, or merged again. The constant route maintenance in the zone and among the zones is not neglect able, even if there is no traffic in the network.
(3) Another hierarchy approach uses grids with cluster head: GRID protocol selects one node in each grid or zone, and these nodes serve as backbone for routing tasks. The issue with this method is that, the gateway node may move in and out of a zone, and then selection process must be restart again. If the grid size is small, the selection process will happen very often; and if the grid size is large then the traffic burden on the gateway may be unbearable. In addition, if the connectivity between grids changed, a global routing update is required in the entire network.
(4) Geographical approach: A few proposed routing algorithms use the location information. The location information can be used to identify a node in a defined region. Therefore the destination search can be limited to such a region. The initial knowledge of the location can be obtained by full network search. As the location of the destination node is known, the data forwarding uses the location information to assist the forwarding in the direction of the destination. Most of the location based routing uses the location in route maintenance as an advantage. For example, LAR is an on-demand routing protocol where location information is used to reduce the search space for a desired route. The initial search for the destination is still proportional to the number of nodes in the network. This approach does help in the later route maintenance, only if the approximate location of the destination is known. DREAM proactively maintains location information at each node in routing tables. Data traffic packets are flooded to nodes in the direction of the destination. GPSR uses only neighbor location information for forwarding data packets. It uses a greedy method by forwarding the packet to a neighbor closer to the physical location of the destination. The problem may arise when the source and destination is not well connected along a straight line.
(5) Some location-based algorithm also makes use of fixed nodes to act as a home agent. A new node in the network registers itself in a fixed node, which becomes its home base. Any search for such a node can find its location in the registry of some fixed nodes. This method is used in the current cellular networks. The problem with this network is the requirement of such a fixed base. The base would have the burden to serve many route request for the near by nodes.

### SUMMARY OF THE INVENTION

This invention is about creating a new routing protocol, called Small Geographical Area Cell-based Dynamic Source Routing (SGA-DSR), for the mobile ad-hoc network systems (MANET). The design of this SGA-DSR protocol has greatly reduced the routing overheads over the many other MANET protocols, such as DSR, DSDV, ADOV, TORA, etc. Because of the routing overhead reduction, SGA-DSR scales very well to fairly large networks, such as having over thousands of nodes. While, most MANET protocols work well in small scale, such as 200 nodes in the network. In SGA-DSR, the route paths are cell-based. The routing routes are much less affected by the dynamics of the topology changes. Small Geographical Area (SGA) is a small cell in contrast to a traditional cellular phone cell site. The cells are tiled regularly in the coordinates of the Longitudes and Latitudes.

With respect to the routing aspects, the mobile may need to broadcast route request to find the route path to the destination node. Unlike many MANET protocols, the route path is not the hops of the intermediate nodes but a geographical path represented by the sequence of SGA cells. When sending or forwarding a route request message, the responsible mobile will either actively select a few momentary representatives (mobile nodes), from the neighbor SGA cells to carry on the forwarding; or, some mobiles may have also volunteered for taking the work unsolicited, for the forwarding (Unsolicited Assistant Mode (UAM)/Unsolicited Assistant Node (UAN)). The momentary cell representative (MCR) or UAM is a local, ad-hoc behavior; it is per packet transmission based. For MCR or UAM to function, the mobile radio range must have covered across a group of SGA-cells, so that there are potential MCR, or UAM/N in all neighbor directions. In response to a single route request, many nodes in the network would be involved in spreading the route request to every corner of the network. In the case of SGA-DSR, the total number of mobiles involving the forwarding is limited by the number of SGA cells in the domain of the network.

SGA-DSR has a great route tracking mechanism. It updates the routes as the mobile moves in the network. The mobile nodes in the network cache the trace of packets they overheard of. The path information will be aged with a timer, or weight. All mobiles in the network would have a partial knowledge of the whole network topology. Most of the time, they keep the parts they need to use the most and the parts they keep are recently refreshed. Therefore the routing information is highly distributed in the network.

### BRIEF DESCRIPTION OF DRAWING

The terms used in describing the figures are defined and given in the table Definition List 1.

FIG. 1 illustrates a simple example of SGA cell layout. There is only one layer of neighbor SGA cells in the area of a Radio Coverage Region (RCR). 101 points to the estimated boundary of the RCR. 102 points to the estimated region of the center SGA cell. 103 points to a neighboring SGA cell surrounding the center SGA cell. The relative SGA cell arrangement is tiled in a hexagonal pattern.

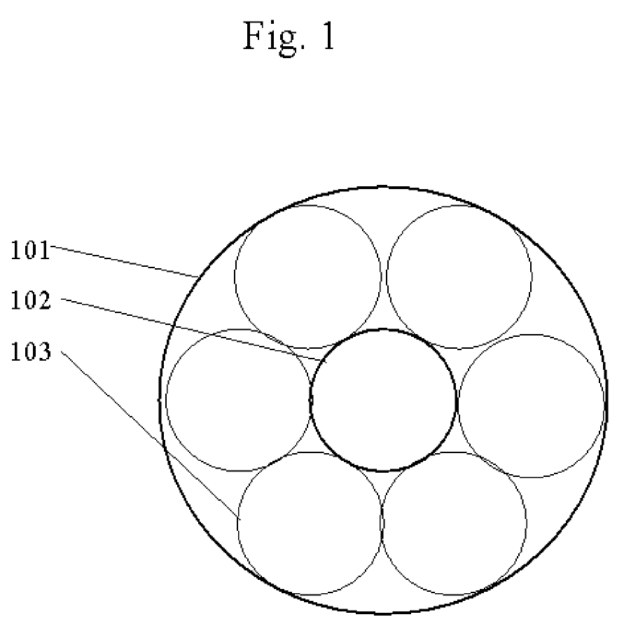

FIG. 2 illustrates another example of SGA cell layout. There are about two layers of neighbor SGA cells in the area of a RCR. 201 points to the estimated boundary of the RCR. 202 points to the estimated region of the center SGA cell. 203 points to two neighboring SGA cells surrounding the center SGA cell. The relative SGA cell arrangement is tiled in a hexagonal pattern.

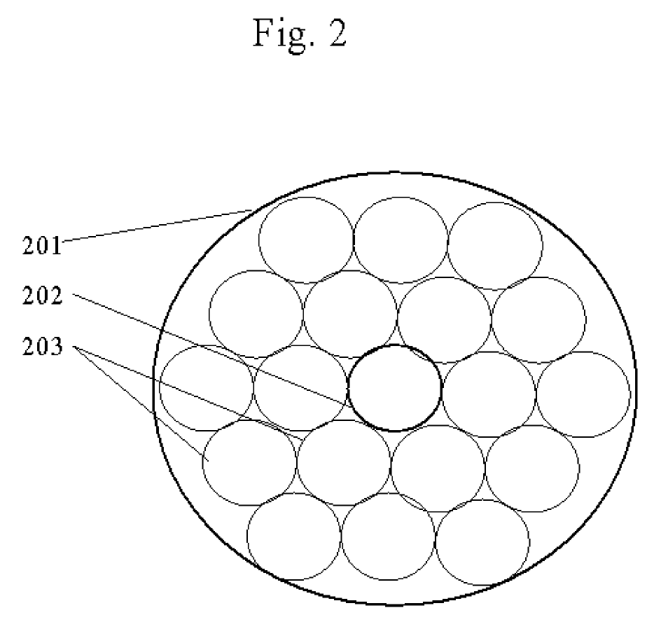

FIG. 3 illustrates a different example of SGA cell layout. There are approximately two layers of neighbor SGA cells in the area of a Radio Coverage Region (RCR). 301 points to the estimated boundary of the RCR. 302 points to the estimated region of the center SGA cell. 303 points to an outer neighboring SGA cell surrounding the center SGA cell. The relative SGA cell arrangement is tiled in a rectangular pattern.

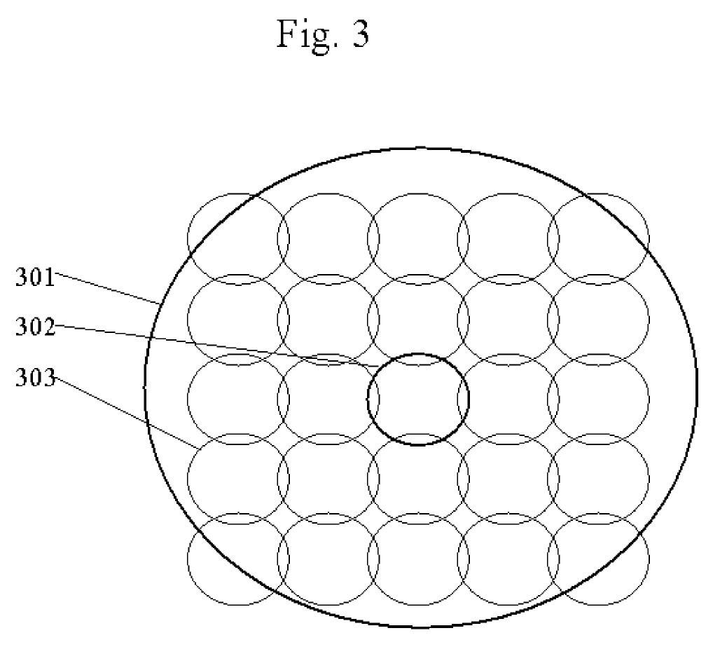

FIG. 4 illustrates the trace of a route request REQ packet, originated by 401 the source node-2, in search of 402 the destination node-I 8. An example of the trace 403 is originated from the source node. Node-1 is a neighbor of node-18 is sending the reply REP packet to the source node. The REQ packet is being forwarded by only one node in each SGA cell. The SGA-DSR works fine in a sparse network.

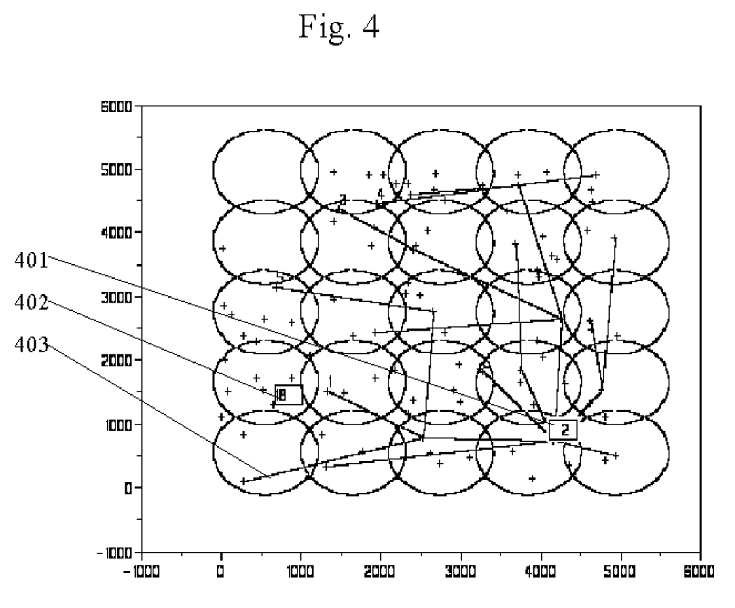

FIG. 5 illustrate the trace of a REQ packet, originated by 501 the source node-2, in search of 502 the destination node-12. An example of the trace 503 is clearly seen as originated from 501, node-2. The number of nodes involved in forwarding the REQ packet is very limited. In every one SGA cell, there is approximately one node taking the responsibility to forward the REQ packet. The forwarding node appears to be an arbitrary one in a given SGA cell. The SGA-DSR works fine in a dense network.

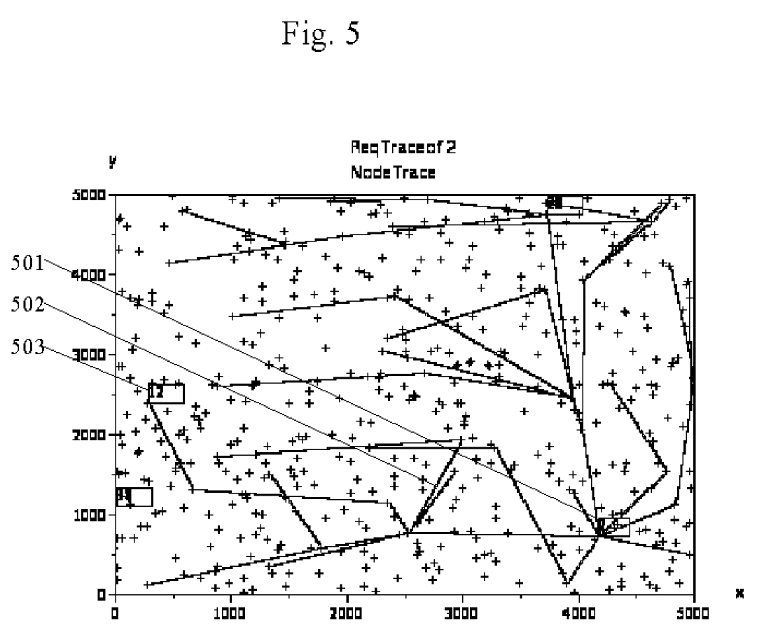

### DETAILED DESCRIPTION

The SGA-DSR Concept and Terms Definitions: The terms are defined so that the concept and method of the SGA-DSR can be better described.

### DEFINITION LIST

The concepts of SGA-DSR can be better presented with the terms defined.

Definition List 1

| Term | Definition |
|---|---|
| PS | Positioning System: It is a system that provides the nodes in the network |
| | of their positions. There are two kinds of PS. The positions can be an |
| | absolute geographical position or a relative position from a known |
| | reference point. Therefore, there are two kinds of PS: Global Positioning |
| | System (GPS) Type: The node equipped with GPS capability would be able |
| | to know its own geographical location and therefore be able to identify |
| | which SGA cell its is currently in. Relative Positioning Type: The network |
| | establishes a set of reference points. The reference points could be |
| | some specific nodes or land marks. The position coordinates are defined |
| | in reference to the reference points. This invention relies on the support |
| | of such a Positioning System, for example GPS. |
| PA | Position Assisted: When not all the nodes are equipped with PS |
| | capability, the neighbor nodes may be able to help. The SGA-DSR |
| | protocol requires the mobiles to be location aware, most of the time. |
| | Sometimes, a mobile may not have the immediate knowledge of its own |
| | position, but by overhearing the location-broadcast of other mobiles, it |
| | would be able to guess approximately its own position. The SGA-DSR |
| | does not require the mobile to have very accurate position knowledge. |
| | The mobile position knowledge can be obtained from a Positioning |
| | System (PS), such as GPS. |
| RCR | Radio Coverage Region: It is defined as the average coverage area by |
| | how far a node can directly communicate with another node in the |
| | network. Two nodes within each other's RCR would have good chance |
| | to be able to communicate. The actual communication can be severely |
| | influenced by the channel impairments and conditions due to object |
| | shadowing, channel fading, etc. |
| SGA | Small Geographical Area: A SGA is a small cell. The boundary of a SGA |
| | cell is defined in the coordinates of the supporting PS. The size of RCR is |
| | multiple times the size of the SGA. The SGA cell boundaries can be |
| | slightly overlapped. There could be regions that are blank, not belonging |
| | to any SGA cells. The nodes located in the overlapped and blank region |
| | can identify themselves as just anyone cell among the closest candidate |
| | SGA cells. The SGA cells are tiled regularly over the whole area. SGA cells |
| | are fixed in the coordinates of the PS. While nodes may move from cell |
| | to cell. A node in a given SGA cell may be able to directly communicate |
| | to another node across a few SGA cell territories. |
| SGA-DNE | SGA-Direct Neighbor Extension is an extended area from a given SGA, to |
| | include the direct neighboring SGA area in the definition. SGA-DNE is |
| | used in the data path construction. A data path in SGA-DSR is defined as |
| | a sequence of SGA cells in which on air data packets can be forwarded |
| | from cell to cell. In such data path if SGA-DNE is used then the nodes |
| | involved in the forwarding activity will be confined by larger SGA-DNE |
| | instead of the smaller SGA. |
| Network Domain | The network domain can be regarded in two different meanings. First, |
| | the domain can be defined as a city or a town. It is a geographic domain. |
| | Second, the network domain can be defined as a fixed number of SGA- |
| | cells away, respective to a given cell. The SGA-DSR works fine with both |
| | definitions. |
| SGA-Cell-Layout | It is a network map using the coordinates in the given PS to define the |
| | SGA cell layouts, cell boundaries, and cell Identities (ID). The average |
| | size of a RCR is first estimated. Then the size of a SGA cell is |
| | determined so that the area of a RCR can cover any SGA cell, and at least |
| | one layer of its surrounding neighbor SGA cells. It is preferred, but not |
| | limited, to have approximately 2 layers of surrounding SGA cells under |
| | the coverage of a RCR. |
| SGA-ID method | SGA Identifying method: A node use the current position information to |
| | associate itself to the SGA cell ID. The SGA cells boundaries are |
| | predetermined in the SGA-Cell-Layout map. If the current position is in |
| | the overlapped region of multiple SGA cells, or a blank region with no |
| | SGA cells. Then the node can pick a candidate cell that is closest to the |
| | cell center. |
| OKA | Optional Keep-alive: It is an option that the mobile should beacon its |
| | keep-alive message. SGA-DSR protocol works both with and without the |
| | keep-alive beacon. Broadcasting the mobile identity and location helps |
| | the Route Request to find the destination more effectively but it is not a |
| | prerequisite (See definition UAM). Periodic broadcasting of keep-alive |
| | may increases the routing overhead. |
| REQ | Route Request: A route request message that is being sent by the source |
| | node in search for a path to the destination node. Each time the REQ |
| | packet is being forwarded by any intermediate node, the node ID and |
| | the associated SGA cell ID are included in the REQ packet. When the REQ |
| | packet has arrived the destination node, the whole path from the source |
| | node to the destination node is recorded in the REQ packet. |
| REP | Route Reply: The destination node sends a route path back to the |
| | source node via a route reply message. Besides the destination node, |
| | any node, which has the route information, in the network may also send |
| | the REP message to the source node. |
| MCR | Momentary Cell Representative: As a mobile is about to send out a route |
| | request packet (REQ), or continue forwarding a REQ, it will actively select |
| | a few nodes, known as momentary cell representatives (MCR) in its |
| | neighborhood to propagate the REQ. The selecting of MCR is purely adhoc |
| | and local to the single transmission. If there were N SGA cells under |
| | its radio coverage, it would pick N MCR, one from each SGA cell. The |
| | MCR name list of nodes is attached to the REQ in the broadcasting. The |
| | MCR name list is only meaningful in the local broadcast. All neighbor |
| | mobiles would overhear of the REQ but only a few would actually take |
| | the responsibility to continue propagate the REQ. Since, the MCR nodes |
| | were located in different cells, scattering in all directions, and preferably |
| | only those cells at the edge of the radio coverage, the number of nodes |
| | involved in actual radio broadcasting is limited to the number of SGA |
| | cells in the RCR. If only the edge cells were considered for selecting the |
| | MCR, then the number of MCR will be further reduced. This method |
| | guarantees the REQ to be forwarded in all directions, and eventually |
| | reaching out to every corner of the network. And the number of SGA |
| | cells in the network limits the total number of transmissions, triggered |
| | by a single request. The routing overhead of flooding of the destination |
| | search (REQ) in a dense network would not increase with the number of |
| | nodes in the network. |
| UAM | Unsolicited Assistant Mode: In UAM, when a mobile overheard of a |
| | forwarding request (such as REQ, or Reply Packet, etc), it will make itself |
| | ready to carry on the forwarding by waiting a random time (for example, |
| | in a range of 5 to 250 milliseconds). If indeed no one else in its cell is |
| | forwarding the packet during its waiting time. It will take action to |
| | forward the packet unsolicited, as if it has been selected to do so. The |
| | use of random time is to reduce the chance of multiple forwarding of the |
| | same request in a single SGA-cell. If mobile A is aware of its neighbor, |
| | the MCR method will be used. But MCR will be backed up by UAM to |
| | ensure that a packet will be forwarded if MCR failed to find any |
| | representatives. |
| UAN | Unsolicited Assistant Node: The node, which is exercising the UAM. |
| UAN-CS | Unsolicited Assistant Node - Candidate Set: Normally all the nodes in a |
| | SGA cell is automatically a member of the UAN-CS. However, if there are |
| | too many nodes in a SGA cell, the network density is exceeding the |
| | capacity of the media access control (MAC), then not all the nodes |
| | should be participated in the UAM at a given time. Then number of |
| | nodes participating in UAM is limited by the capacity of the MAC layer. |
| | Now, set two threshold sizes (THS) for the UAN-CS. THS-1 is the |
| | minimum size threshold, THS-2 is the maximum size threshold. The |
| | nodes in a GSA cell will join into, or release themselves from the UAN-CS |
| | club from time to time. When the number of members in the UAN-CS is |
| | falling below the THS-1 then the nodes outside the UAN-CS club will |
| | contend to join with a probability within a given time frame. During the |
| | whole process, every node is also monitoring the size increments in |
| | UAN-CS against the THS-1. If the size is already exceeded the THS-1 |
| | then the node will pause, or slow down, its joining process until the size |
| | is falling below the THS-1 again. When the number of members in the |
| | UAN-CS is exceeding the THS-2 then the nodes inside the UAN-CS club |
| | will contend to release themselves with a certain probability within a |
| | given time frame. At the same time every node is also monitoring the |
| | size of decrements in the UAN-CS club against the THS-2. If the size is |
| | already below the THS-2 then the node will pause, slow down, it |
| | releasing process until the size is exceeding the THS-2 again. |
| CS-MR | Candidate Set - Membership Rotation: Rotation and circulation of the |
| | membership in UAN-CS club is also executed to ensure fairness in |
| | supporting the network. Every node in the UAN-CS club will increase its |
| | probability to release itself from the club over the age of its membership |
| | if the UAN-CS size has been above THS-1. Therefore the nodes staying |
| | long enough in the UAN-CS will be more likely to release from the |
| | UAN_CS club. The process will cause a dynamic circulation of |
| | membership in the UAN-CS club. The nodes, which are currently the |
| | active members of the UAN-CS club, will be able to readily access the |
| | network via the MAC layer. |
| ERP | Explicit Route Path: It is a path represented by a sequence of SGA cells. |
| | ERP is extracted from the routing table. It is used to indicate how a |
| | packet can be forwarded. |
| RG | Route Graph: The SGA cell is the building unit of the RG. It is a |
| | mathematical model - graph. The RG represents the network topology |
| | learned by the node in the recent time. An edge in the RG represents the |
| | existence of connectivity between two SGA cells. The edges are |
| | weighted and timed. The edge will be removed if it has been time out. |
| | The edge weight is given a value to reflect the order of priority. For |
| | example, a newly learned edge, against older edges, will be given a |
| | better weight. |
| NT | Node Table: The NT keeps the mappings of a node to a SGA cell. When a |
| | node is storing a learned path into the routing table. The information of |
| | node ID mapped to SGA cell ID is extracted and stored in the NT. The |
| | path sequence of SGA cells is decomposed into edges and stored in the |
| | RG. The node in NT is also timed. The node to SGA cell mapping will be |
| | removed if it has been time out. |
| Node-Timer | Each node in the NT is timed. The default value of the timer is a |
| | predetermined system parameter. The node will be refreshed by |
| | receiving packets having the newly obtained route information, or by |
| | overheard such packets. |
| Edge-Timer | Each edge in the RT is timed. The default value of the timer is a |
| | predetermined system parameter. The node will be refreshed by |
| | receiving packets having the newly obtained route information, or by |
| | overheard such packets. |
| DP | Data Path: A DP is a route path that is currently being used, carrying |
| | data traffic. In contrast, an ERP is only an entry in the information |
| | database. An ERP is obtained directly from the RG and NT. The |
| | continuously use of a DP, in return is refreshing the route paths in the |
| | RG and NT. The nodes in the SGA cells defined in the ERP carries the |
| | data-forwarding task via MCR and UAM. But the scope of MCR and UAM |
| | would apply to SGA cells confined by the ERP. |
| DP-W | Data Path-Widened: Data Path - Widened (DP-W) is a widened data path |
| | based on an existing DP. DP-W is an extension feature to the DP. DP-W |
| | uses the SGA-DNE cell for data forwarding instead of SGA cells. Each |
| | SGA-DNE is directly mapped to the corresponding SGA cell in the DP. |
| | The number of nodes increases, in serving the data traffic. The DP-W |
| | serves better when the network is, no having enough nodes, a sparse |
| | network. |
| SD | Shortcut to Downstream: An SD is local a route repair mechanism. When |
| | a packet forwarding along the DP is stopped by a broken link, the node |
| | will initiate an SD, a route request to find a shortcut to the downstream |
| | nodes in the ERP. The SD request has a very short (Time To Live) TTL, |
| | such as one. Any near-by nodes (including the SD sender itself) that |
| | have the path to any SGA cells in the downstream nodes of the ERP will |
| | reply to the sender. The SD sender will collect the new path information |
| | and bring it back to the source node in an RTP. The source node upon |
| | receiving the RTP will recalculate the path to the destination. Packets are |
| | then sent out along a new ERP. If the Path Tracking is successful, the |
| | data packet forwarding will continue at the SD sender node. If SD failed |
| | to find any path to the downstream of the path, then the packet is |
| | dropped. |

### DESCRIPTIONS

The SGA-DSR is a new protocol design based on the special relationship of the SGA cell arrangement to the area of RCR. The special relationship enables many different routine features of SGA-DSR that are not found in any other ad-hoc network protocols.

The SGA-DSR is composed of two major methods: SGA-DSR Route Discovery and SGA-DSR Route Maintenance.

Route Discovery:
(1) Route Request (REQ)
   In SGA-DSR, if OKA is enabled, all route paths to the direct neighbor nodes are readily available. Regardless OKA is enabled or not, all mobiles must support Unsolicited Assistant Mode (UAM).
   With no knowledge of where to find a destination mobile, the mobile may have to send out a route request packet (REQ) for route discovery. This packet contains a route record, a record of the sequence of SGA cell ID, and node ID traversed by the REQ, as it propagates through the network.
   It also contains a request id, to identify the duplicate (or old) packets from the given source node.
   If a node has heard of the REQ and it has the requested path information. It will send a reply packet (REP) back via the return path. On the way back to the source node, if the return path link is broken, then the reply REP will be dropped.
   If a node receives a route request packet with a source address and a request id already received, it discards the packet. Otherwise, it appends its node ID and SGA cell ID to the route record.
   Upon receiving a REQ packet, the node must prepare itself in the Unsolicited Assistant Mode (UAM). If it finds its node ID in the MCR name list of the REQ, it will propagate the REQ, if the destination route information is not available in its route table. If it is not in the MCR list, it will be waiting in UAM process. It will transmit the REQ packet when the UAM timer expired, if no other node has already transmitted the same REQ packet during its waiting period. If it detects another transmission by a neighbor node that is located in the same cell, then it will discard the REQ packet immediately. No further action is required.
   The use of MCR and UAM ensures that the REQ packet with limited radio resource and the packet is being heard in all directions. The limited number of SGA cells also limits the number of transmissions of a single REQ in the search of a destination in the whole network. The route request overhead has been significantly reduced.
(2) Route Reply (REP)
   A route reply packet (REP) contains the requested path information (from source node to the destination node).
   It also contains an Explicit Route Path (ERP) back to the source node. The path information or the Explicit Route is a sequence of the SGA cells that a packet can be forwarded to the destination. The REP packet forwarding is not done by a SGA cell, but by one of the nodes currently inside the cell. Therefore the design of the cell radius should not be too small.
   Forwarding along the explicit path of SGA cells, a packet may be carried away by a moving node to the near-by cell, which may no longer be on the path, ERP. The respective node should continue to forward the packet to the downstream cells, if possible.
(3) The Route Table: Route Graph (RG) and Node Table (NT)
   The route information is stored in a Node Table (NT) and a Route Graph (RG). The node to SGA mapping has an expiration timer, called Node-Timer. The expiration timer should be a configurable system parameter. The RG has a set of edges with weights. An edge is a pair of directly connected SGA cells. The edge is timed with an Edge-Timer. A reasonable expiration timer value could be ranged from a few seconds to a few hours. The timer in the NT and RG entries will be refreshed by new route information.
   In search for a destination, if the route information in NT and RG is not available, then a REQ is sent.
   The node extracts route information from the packet trace it overheard. The refreshed edge weight can be set to a minimum (such as 1). Less weight means more important.
   Route information can be transported. When inserting external route information obtained from other nodes, the original edge weight should be kept. If the edge weight is not available, a less important weight value must be given to those uncertain edge entries.
   The whole network topology is highly distributed in the nodes. No single node is required to have the full knowledge of the network topology. The NT and RG have only the recent routes that it uses. All old routes will be deleted as the timer expired. In the calculation of a destination path, the edge weight (increases with time) would allow the algorithm to choose a more recent and refreshed path.
   In route discovery, when a REQ message sent, does not result in any REP packets coming back to the source. The source node may retry for a number of times. The number of retry is a predetermined system parameter.

Route Maintenance
(1) Route Tracking
   SGA-DSR does not actively detect network topology changes. But if a data packet has failed to propagate in the data path DP, along an explicit route path ERP, then a Route Tracking Packet (RTP) should be generated and returned to the source node. All intermediate nodes heard of such an RTP should also update its routing table, the NT and RG. The RTP contains the information about the broken link; for example, the broken link is specified as from SGA cell A to SGA cell B. It may also contain potential new path information to the downstream leading to the destination (Ref: Shortcut to Downstream, SD in the next section).
   Each entry in the route table, NT and RG has an expiration timer, the Node-Timer and Edge-Timer. After the timer expires, the entry is removed from the cache. While receiving of packets from the destination, or overheard traces packets, the timer of the associated edge is refreshed. If an RTP is received, the corresponding broken edge, or the node-SGA cell association will be removed from the routing table, RG and NT.
(2) Local Repair Method
   SGA-DSR does a simple local repair to a broken link, by using SD. Because SD is a short local request, the waiting for a potential reply should be very short.
   In the case that the RTP packet cannot find a route back to the source node of the packet, the RTP will simply be dropped. Since RTP is a kind of error packet, dropping an error packet will not further trigger new error reporting packets.
   In case that the destination node is not found in the last SGA-cell of the ERP, then repair mechanism SD is extended to the last node in the ERP. The node who receives the packet will search (send a one hop request) for the destination in the its direct neighboring SGA-cells. If it is found, the packet will be forwarded to the destination. Else, the packet will be dropped and a RTP will be generated, causing the source to remove the destination node mapping to the existing destination SGA cell.
   The route maintenance is on demanded. No global repair or maintenance is required.
(3) Data Forwarding and Route Tracking Method
   If the route path to the destination node is found in the routing table, NT and RG, data packet can be sent with an ERP, forming a DP. The DP may be changing slightly as the data packet is actually forwarded from node to node, or cell to cell. The route is refreshed along the path, as the traffic is flowing on such DP. But any route change is also tracked and updated.
   During the data communication, the nodes in the network may have moved over time. At some point of time, the data path may be disrupted by instability of some links. The SD mechanism does the local repair if possible and RTP is also generated to modify the current ERP at the source node.

In SGA-DSR, the route change in the DP due to the node mobility is relatively small. In a dense network, the cells are mostly likely to be filled with nodes. As a SGA cell based forwarding, any node in a specific cell can be momentarily engaged to bridge the communication. In a sparse network, the data path DP would be more likely broken due to the physically breaking of the network.

In SGA-DSR, the network topology information is distributed in different nodes. The nodes only keep the partial network information they needed.

What is claimed is:

1. A method for finding network routes and routing data packets in an ad-hoc network comprising: (a) network nodes equipped with capability of PS, or PA, (b) an SGA-Cell-Layout map, (c) a routing method.

2. The closure of claim 1 wherein further comprising a SGA cell identifying means for a node to map its current location to the corresponding SGA cell ID according to SGA-ID method.

3. The closure of claim 1 wherein said SGA-DSR Routing method further comprising: (a) route discovery method, named SGA-Route-Discovery, and (b) route maintenance method, named SGA-Route-Maintenance.

4. The closure of claim 3 wherein said SGA-Route-Discovery method further comprising: (a) a route request method, (b) a route reply method, and (c) a route table method.

5. The closure of claim 3 wherein said SGA-Route-Maintenance further comprising: (a) a route tracking method, (b) a local repair method, and (c) a data forwarding and route tracking method.

6. The closure of claim 4 wherein said route request method further comprising: (a) OKA method, it is optionally configured, (b) sending REQ method, the mobile may have to send out a REQ packet for route discovery, (c) sending REP packet method, if a node has heard of the REQ packet and it has the requested path information; it will send a reply REP packet back via the return path, (d) MCR method, a sender node may prepare a list of neighbor nodes to further forward the packet, (e) UAM method, upon receiving a packet, the node must prepare itself in the UAM as a backup to MCR; nodes exercising UAM are named UAN.

7. The closure claim 6 wherein said UAM further extended to include an active UAN method comprising: (a) a limited set of nodes, defined as UAN-CS, (b) membership rotation method, defined as CS-MR.

8. The closure of claim 2 wherein further comprise a data forwarding method, comprising: (a) setting up a data path method, a packet is being sent via the nodes in the ERP cells; (b) sending data in the DP scheme, or (c) sending data in the DP-W scheme.

9. The closure of claim 4 wherein said route reply method further comprising sending route REP packet method, a REP packet contains the requested path information, from source node to the destination node; it also contains an ERP back to the source node; the packet are forwarded in the DP, or DP-W scheme.

10. The closure of claim 4 wherein said route table method further comprising: (a) a node table, known as NT, the node ID and associated SGA cell ID is extracted from the path information in the received, and overheard, packets and stored in the NT; the node mapping is timed with a Node-Timer, (b) a route graph, known as RG, the SGA cell to cell connectivity is extracted from the path information in the received, and overheard packets; the edge is inserted into the RG; the graph edge is timed with an Edge-Timer, (c) path computing method, in the NT, the source node and destination node are used to determine the beginning SGA cell ID, denoted by SGA-A, and destination cell ID, denoted by SGA-B; in the RG, the SGA-A and SGA-B represents two points on the graph RG; a path can be computed; the edge is weighted in the RG; the weight can be a constant for each edge, or the edge can be weight differently on a preference scale; it is preferred to give a better weight for the edge that has been refreshed most recently, (d) a route deletion method, the entries in the NT are timed with Node-Timer and entries in the RG are timed with Edge-Timer; when the timer is not refreshed and timed out then the entry will be removed from the respective table.

11. The closure of claim 5 wherein said route tracking method further comprising: (a) a broken link detection method, when a data packet fails to propagate in the data path, DP, or DP-W, then the broken link information is collected, (b) a error reporting method, when a broken link is detected, a RTP is generated and sent back to the source node; the broken link information is included in the RTP; all intermediate node overheard of the RTP would also update their routing table NT and RG.

12. The closure of claim 5 wherein said local repair method further include a local route request mechanism, when a data packet cannot be further forwarded to the downstream SGA cells, a broken link is detected; the said local route request mechanism will generate a route request packet, also known as SD packet, in the surrounding SGA cells, to find a new short cut to the downstream of the DP; the local route request mechanism is optionally extended to the last SGA cell in the ERP, in reaching for the destination node.

13. The closure of claim 5 wherein said data forwarding and route tracking method is directed to refresh the routing table, the NT and RG as data path DP could be changed overtime due to node movements.
